(19) United States
(12) Patent Application Publication
(10) Pub. No.: US 2010/0047156 A1
(43) Pub. Date: Feb. 25, 2010

(54) MULTIPLE STAGE REVERSE OSMOSIS METHOD FOR REMOVING BORON FROM A SALINATED FLUID

(75) Inventors: Menachem Priel, Ramat Gan (IL); Nissim Nadav, Herzlia (IL)

Correspondence Address: THE NATH LAW GROUP, 112 South West Street, Alexandria, VA, 22314, US

(73) Assignee: MEKOROT ISRAEL NATIONAL WATER COMPANY, LTD., Tel-aviv (IL)

(21) Appl. No.: 12/310,131

(22) PCT Filed: Aug. 15, 2007
(86) PCT No.: PCT/IL2007/001022

§ 371 Date: Sep. 22, 2009

Related U.S. Application Data
(60) Provisional application No. 60/837,632, filed on Aug. 15, 2006.

(51) Int. Cl. B01D 61/04; C02F 1/44; B01D 61/02; C01B 5/00

(52) U.S. Cl. 423/580.1; 210/639; 210/201

(57) ABSTRACT

The presently described subject matter provides a method for reducing boron concentration in a process of desalination of high salinity liquid including passing the high salinity liquid through a first pass reverse osmosis (RO) device to produce a first pass permeate, where at least part of the first pass permeate is treated with a scale inhibitor to obtain a modified first pass permeate being fed into at least one additional RO device to produce at least an additional pass permeate, where the at least one additional pass permeate includes a lower boron concentration than that in the high salinity liquid.

### FIELD OF THE INVENTION

This invention relates to water treatment and in particular to reducing boron concentration in the water.

### BACKGROUND OF THE INVENTION

Boron is present in significant concentrations in seawater and in many natural brackish waters. Typical seawater has Boron concentrations of approximately 4-6 parts-per-million (ppm).

Organizations such as the World Health Organization (WHO) and the Environmental Protection Agency (EPA) have proposed drinking water regulations having various limits for Boron concentration. Particularly, the WHO has proposed a strict provisional Boron concentration limit of 0.5 ppm, while the EPA has set forth a more lenient Boron limit of 3 ppm for adults and 0.9 ppm for children In some jurisdictions the concentration of Boron in drinking water is regulated (e.g. Europe, Canada, Minnesota). In others, like in Israel, regulations are still under consideration. Specifically, Europe has a Boron limit of 1 ppm, Canada has a Boron limit of 5 ppm and Minnesota has a Boron limit of 5 ppm.

Treatment options for reducing Boron concentration in drinking water include reverse osmosis (RO) and ion exchange processes. Several types of ion exchange resin are employed for Boron removal, including: (1) the use of a Boron specific resin consisting of a styrene-DVB backbone with N-methyl glucamine active sites; and (2) the use of a mixture of conventional strong-acid-strong-base mixed bed resins.

Although the reduction of the majority of dissolved ions, e.g. chlorides, by reverse osmosis membranes, is about 98% to about 99%, the rejection rate of boron by these membranes is much lower, typically in the range of 70%-90%, and may be even lower at high feed water temperatures (greater than about 25° C.). To increase boron rejection rate, the pH of the water is increased, leading to an increase in dissociation of the boric species to borate. This way the borate species are much larger in particle size thereby aiding their removal.

Magara, et al. (Desalination 118:25-34 (1998)) and Prats, et al. (Desalination 128:269-973 (2000)) describe methods for reducing boron concentration using two-pass RO systems. In these systems, the pH of permeate from the first pass is increased before it is passed through the RO membrane in the second pass in order to improve the boron rejection.

The term “permeate” is known in the art to refer to RO product water. The RO permeate from these systems has low salinity and hence, even adjustment of the acidity of the solution to higher levels of pH does not result in scale formation of calcium, barium, strontium, iron and various silicates but may result in scale formation of magnesium hydroxide. Further, the industrial application of such a method is quite straightforward and results in effective boron reduction.

However, the known desalination methods making use of two pass RO processing typically result in a decrease in the overall recovery rate since the overall recovery rate is the product of the recovery rates of the first and second passes. The second pass RO usually operates at a recovery rate of about 80% to 90%, so that only about 80 to 90% of the feed to the second pass is converted to the final product, while the remaining 10-20% is discharged as concentrate.

Increased recovery results in an increased concentration of sparingly soluble salts and higher scaling potential. For example, at 50% recovery, the concentration of soluble salts in the concentrate is twice that of the feed. In contrast, when the recovery is increased to 90%, the concentration factor increases by a factor of 10. Considering that the first pass permeate is produced at relatively high capital and operating cost, the recovery rate of the second pass RO significantly affects the cost of the final purified water. Therefore, maximizing the recovery rate of the second pass RO device, while simultaneously minimizing scaling, is desirable.

WO05/056166A1 describes methods and systems for increasing the recovery rate in multi-pass RO systems for treating high salinity boron-containing liquids, such as seawater, to reduce salinity and boron concentration. A first system described therein is shown herein with reference to FIG. 1A and a second is shown with reference to FIG. 1B. In the following description like elements to those in the prior art configuration depicted in FIG. 1A will be given like reference numerals shifted by 20 for FIG. 1B (for example, feed 23 in FIG. 1B is functionally the same element 3 in FIG. 1A). Specifically, a treatment system 10 is shown in FIG. 1A, where high salinity liquid feed 3 is pumped by high pressure pump 6 to a first pass RO membrane unit 1. In membrane unit 1, the high salinity liquid feed is separated into two streams: concentrate 5 and permeate 4. The pH of permeate 4 is then adjusted with base 7 to a pH of about 10. Base-adjusted permeate 4 is then pumped to a second pass RO membrane unit 2, in which it is processed to produce permeate 8 and concentrate 9. FIG. 1B shows a second configuration described in WO05/056166A1 where high salinity liquid feed 23 in the treatment system 20 is pumped by a high pressure pump 26 to a first pass RO device (membrane unit) 21. In membrane unit 21 the high salinity liquid is separated into two streams: concentrate 25 and permeate 24. The pH of permeate 24 is adjusted with base 27 to a pH of about 10, and then pumped to a second pass RO device (membrane unit) 22 where it is processed to produce permeate 28 and concentrate 29. Concentrate 29 is then processed through an ion exchange unit IX utilizing a boron specific resin. Finally, the effluent 33 of the ion exchange unit is blended with permeate 28 to produce a blended flow 31. The process parameters for these two prior art configurations are tabulated in Example 1.

A further multi-pass RO system for treating high salinity liquids is described in JP 9290275A2. Specifically, this publication describes a two-pass RO system where boron is allegedly removed in the second pass.

U.S. Pat. No. 7,097,769 relates to a method of boron removal from saline water containing boron and magnesium or calcium salts including a multi-stage reverse-osmosis (RO) separation process. The first stage separation is carried out at a pH<8.2. The second stage separation is carried at pH>9. The third stage separation is carried at weak-acid pH, whereby the bulk of the magnesium or calcium ions are separated with the brine, while the bulk of the boron ions are retained in the permeate. In the fourth stage of separation over the third-stage permeate, the bulk of the boron ions is separated from the third-stage permeate, and the permeate of the fourth stage constitutes product water with low boron content.

### SUMMARY OF THE INVENTION

The present invention is based on the findings that in a process of desalinating high salinity liquids, treating the high salinity liquid (e.g. seawater) by adding to the permeate from the first pass a scale inhibitor optionally together with a base (e.g. sodium hydroxide also known as caustic soda) significantly increased the recovery rate of the water from the second pass permeate to 95%, while simultaneously substantially reducing boron concentration in the liquid at the user point, i.e. the liquid to be supplied to the users which is suitable for drinking. The product of the treatment of the first pass permeate with the scale inhibitor and optionally further with a base is referred to herein at times by the term “modified first pass permeate”.

Thus, in accordance with one aspect of the invention there is provided a method for both increasing the recovery rate of purified water and further reducing boron concentration in high salinity liquid in a desalination process, comprising passing said high salinity liquid through a first pass reverse osmosis (RO) device to produce a first pass permeate; treating at least part of said first pass permeate with a scale inhibitor to obtain a modified first pass permeate, feeding the modified first pass permeate into at least one additional RO device to produce at least one additional pass permeate, thereby obtaining desalinated liquid having a boron concentration lower than that in the high salinity liquid. In one embodiment, the treatment with a scale inhibitor is performed in a pH value of at least above 10.

In accordance with one embodiment, there is provided a method for reducing boron concentration in the process of desalination of high salinity liquid comprising:
(i) passing said high salinity liquid through a first pass reverse osmosis (RO) device to produce a first pass permeate;
(ii) treating said first pass permeate, or at least a portion thereof, with a base to adjust the pH value of said first pass permeate to be at least above 10 and with a scale inhibitor to obtain a modified first pass permeate;
(iii) passing the modified first pass permeate through at least one additional RO device to obtain at least one additional pass permeate with a boron concentration lower than that in the high salinity liquid.

In accordance with yet another embodiment there is provided a method for reducing boron concentration in high salinity liquid containing boron, the method comprising:

(i) passing high salinity liquid through a first pass reverse osmosis (RO) device to produce a front first pass permeate and a rear first pass permeate;

(ii) treating the rear first pass permeate, or at least a portion thereof, with a base to adjust the pH value of said rear first pass permeate to be at least above 10 and with a scale inhibitor, to obtain a modified first pass permeate;

(iii) passing the modified first pass permeate, or at least a portion thereof, through at least one additional pass RO device to produce at least one additional pass permeate;

(iv) combining said front first pass permeate with said at least one additional pass permeate to produce desalinated liquid (blended flow) with a boron concentration lower than that in the high salinity liquid.

Thus, the invention provides desalinated liquid having a reduced boron concentration of less than 0.5 ppm, the desalinated liquid obtainable by the method of the present invention.

In accordance with a further embodiment of the present invention, the scaling inhibitor is specific for at least Mg(OH)₂.

In accordance with an embodiment of the invention, the high salinity liquid is seawater and the liquid thus obtained is water having a boron concentration of less than 0.5 ppm. In another embodiment said boron concentration obtained is less than 0.4 ppm and, in a further embodiment said boron concentration obtained is less than 0.3 ppm.

### BRIEF DESCRIPTION OF THE DRAWINGS

In order to understand the invention and to see how it may be carried out in practice, specific embodiments will now be described, by way of non-limiting example only, with reference to the accompanying drawings, in which:

FIGS. 1A and 1B are schematic flow diagrams of known two pass RO systems (prior art) (These figures were taken from WO05/056166A1);

FIG. 2 is a schematic flow diagram of a high salinity fluid treatment method according to an embodiment of the invention.

### DETAILED DESCRIPTION OF EXEMPLARY EMBODIMENTS

The present invention is directed to methods based on a two pass reverse osmosis (RO) technology, for substantially decreasing boron concentration and salinity in high-salinity, boron-containing liquids, such as seawater, while increasing the recovery rate of the treated water.

By manipulating the first pass permeate obtained, after passing of a high salinity liquid via a first pass RO device, with a combination of a pH adjusting agent and a scale inhibitor, a significant increase in the recovery rate from the second pass RO system is achieved, which results in an overall higher recovery rate as compared to hitherto known methods. In addition, said treatment also provides, at the end of the desalination processing a liquid with a significantly lower boron concentration. Thus, the methods of the present invention provide a dual effect of increasing recovery rate of the liquid in a desalination process concomitant with reducing boron concentration therein.

The term “high salinity liquid” may be understood to mean any liquid having a salt content of at least about 1000 ppm of total dissolved salts (TDS), and more preferably greater than about 10,000 ppm TDS. According to one embodiment, the high salinity boron-containing liquid is seawater from seas, e.g. Gulf, Red Sea, Mediterranean and Oceans, water from various salt lakes and ponds, high brackish water sources, brines, contaminated water from industrial and home waste and other surface and subterranean sources of water having ionic contents, which classify them as saline.

The methods of the invention involve treating the high salinity, boron-containing liquid with at least two pass RO systems. In one embodiment, the high salinity, boron-containing liquid is passed through a first pass reverse osmosis device, operating at a recovery rate of about 40 to 60%, in a further embodiment between about 45% to 50%, to produce a first pass concentrate and a first pass permeate. This first pass permeate is then treated with a base to elevate the pH value to be at least above 10, in combination with a scale inhibitor which is injected to the pH-adjusted first pass permeate to produce a modified first pass permeate. The modified first pass permeate is then passed through at least one additional pass RO device to produce at least one additional pass permeate. It has now been found that this addition of a scale inhibitor permits the increase the pH without risking the formation of scales. The combined treatments further results in a substantially higher boron rejection by operating the second pass RO system at these pH levels, higher than conventionally used by other two pass RO systems.

The method of the invention comprises passing the high salinity liquid through a first pass reverse osmosis (RO) device to produce a first pass permeate; wherein at least part of the first pass permeate is treated with at least one pH adjusting agent (e.g. a base, to adjust the pH value to be at least above 10) and a scale inhibitor specific for at least magnesium hydroxide to obtain a modified first pass permeate. The modified first pass permeate is then passed through at least one additional RO device (typically comprising an array of RO membranes. It should be noted that the term “RO membranes” as used herein denotes at least two RO membranes which may be arranged in several RO devices/units, as discuss below) to produce at least one additional pass permeate thereby obtaining desalinated liquid having a boron concentration lower than that in the high salinity liquid.

Passing the high salinity liquid through a first pass RO device provides a front first pass permeate to and a rear first pass permeate. The rear first pass permeate, or a portion thereof, is then treated with the base for pH adjustment and a scale inhibitor from which the modified rear first pass permeate is produced. The modified rear first pass permeate, or at least a portion thereof, is then passed through at least one additional RO device to produce at least one additional pass permeate. The front first pass permeate and the at least one additional pass permeate are then combined to form a blended flow of desalinated liquid to be delivered for use.

It is to be noted that the front permeate has inherently a low boron content that meets the criteria of boron with no additional desalination and therefore appropriate for mixing with the second pass permeate. On the other hand, the rear permeate has a substantially high boron concentration (more than double than the boron concentration at the front at split of 50%), higher than the front permeate, thus requiring further desalination processing.

It is further to be noted that in accordance with the invention the said at least a portion of said first pass permeate may first be treated with the base followed by treatment with the scale inhibitor and vice versa, and the order of addition of the two treatment components is irrelevant, as long as the pH and scale inhibitor concentration in the liquid fed to the second pass RO units is at the desired parameters.

The first pass RO device is typically seawater reverse osmosis (SWRO) unit as known to those versed in the art. SWRO membranes are the tightest desalination membranes and are characterized by their high salt (all ions) rejection. The SWRO membranes are operated at high pressure, 55-82 bar, depending on membrane type, and because of their low flux, the SWRO requires a large number of SWRO membranes to produce large quantity of water. Types of SWRO to be employed by the method of the inventions include, without being limited thereto SWC4⁺ of Hydranautics.

RO devices following the first pass RO may include several RO stages composed of several SWRO membranes as well as other membranes, such as those known to be used for desalination of rear permeate (second pass desalination, such membranes are generally referred to by the term PWRO—Permeate Water Reverse Osmosis).

The bases for pH adjustment used in the methods of the invention may be any strong chemical base which is capable of elevating the pH of high salinity liquids to alkaline pH values of at least above 10. In one embodiment, the alkaline pH range is between about 10 to about 11. In another specific embodiment, the alkaline pH range is between 10 to 10.4. In a further specific embodiment, the alkaline pH is 10.3. In one embodiment, the base is an inorganic base. A mixture of bases may also be used in the context of the invention. Non-limiting examples of bases for use in the methods of the invention are sodium hydroxide, and potassium hydroxide.

The scale inhibitor is any chemical substance capable of preventing the formation of mineral salts deposit. Hitherto, scale inhibitors are injected into liquid before the latter is fed into any RO membrane (including the first pass RO device). Introducing a scale inhibitor after passing the liquid via the first pass RO device in combination with the pH adjusting agent and at least one additional RO pass, improves the quality of the desalinated liquid (the final product) with respect to several parameters, including, inter alia, the boron concentration therein (which is reduced).

Typical scales which are formed in high salinity fluids include calcium carbonate, calcium sulfate, barium sulfate, strontium sulfate, iron sulfide, iron oxides, iron carbonate, and various silicates, or any of a number of compounds insoluble or slightly soluble in water. Typical scale which is formed in low salinity fluids like RO product includes magnesium hydroxide. In the context of the present invention, the term “scale inhibitor” may be used interchangeably with the term “anti-scalant”. Types of scale inhibitors are known in the art and include any substance capable of preventing at least Mg(OH)₂ scaling. These include polyelectrolyes and mixtures thereof, such as polycarboxylates, polyacrylates, polyphosphonates, polysulfonic acids, polyphosphonic acids, and polyphosphates. None limiting examples of a scale inhibitor in accordance with the invention are sodium-1-hydroxyethylidene-1,1-diphosphonate (HEDP, such as PermaTreat® PC-1020 or equivalent such as PermaTreat® PC-1850 ONDEO, Nalco, Europe BV), polyamino polyether methylenephosphonate (PAPEMP), 2-phosphonobutane-1,2,4-tricarboxylic acid (PBTCA), polymaleic acid (PMA), aminotri(methylene phosphonic acid) (AMP), hexamethylene diamine tetra (methylene phosphonic acid) (HDMTMP), copolymer of acrylic acid and acrylamido-2-methylpropylsulfonic acid (AA/AMPS), phosphoncarboxylic acid (POCA), polyacrylic acid having molecular weight of about MW 100 to about 5000, and an anti scalant compositions comprising polyacrylic acids, e.g. Tripol 9010™ (TriSep Corporation).

The methods of the invention may also use a combination of scale inhibitors. Further, it is noted that additional steps of anti-scale treatment may be employed during the stages of the second pass RO processing.

According to one embodiment, the scale inhibitor is selected so as to prevent the deposit of magnesium hydroxide (also known as Brucite) and/or Calcium Carbonate. In one embodiment the dosage of scale inhibitor is about 0.5 to about 5 ppm.

According to one embodiment, treatment of the first pass permeate to obtain the modified first pass permeate is performed in-line while the high salinity liquid flows. Following determination of the pH, a first dosing pump which is fed from a first tank injects the base into the in-line fluid followed by the injection of the scale inhibitor from a second tank using a second dosing pump. It is to be noted that the rate of injection of the base is a function of the ionic composition of the SWRO permeate (the said at least a portion of the first pass permeate) and is to be determined during an a priori pilot test. Those versed in the art would know how to determine this rate based on commonly known criteria. The injection rate of the scale inhibitor is between about 3 mg/liter to about 4 mg/liter. According to one embodiment, the dosing pumps have an automatic feedback which automatically monitor and control the amount of base and scale inhibitor which are injected to the flowing liquid.

Following pH adjustment and anti-scale treatment, the modified first pass permeate is processed, at elevated pH and in the presence of the scale inhibitor, by a second pass reverse osmosis system, operating at a recovery rate of about 85% to 98%, in another embodiment between about 90% and about 98%, in a further embodiment at about 95% or more, to produce the second pass permeate.

It has been surprisingly found that when the modified first pass permeate is fed into the second pass RO system in the presence of the scale inhibitor at a higher pH than typically used, e.g. higher than 10, the recovery rate from this second pass RO system is substantially higher than that obtained when no anti-scalant treatment is provided between the two RO treatments or is provided before RO processing is initiated (as clearly depicted in Table 1 hereinbelow).

The method of the invention is effective at reducing the boron concentration to less than 0.5 ppm, in one embodiment less than 0.4 ppm, in a further embodiment less than about 0.3 ppm and the total salinity to 100 to 200 ppm. There are different techniques for measuring boron concentration in a liquid. One such technique is the Ion Coupled Argon Plasma (ICAP).

The RO devices and units comprise membrane elements which may be arranged in an array to form a sequence of desalination processes. According to one embodiment, the membrane elements are preferably polyamide type membranes having slight or excessive negatively charged surfaces. Other negatively charged separation membranes, such as polyacrylic acid, may also be used. Typical spiral wound reverse osmosis membrane elements which are commercially available are about 100 mm×about 1000 mm or about 200 mm×about 1000 mm, but any membrane configuration or dimension known in the art would be applicable for the methods of the invention.

The liquid may be passed through the RO membrane at ambient temperature or at slightly reduced or slightly elevated temperatures. More particularly, the methods would be effective at a normal temperature range for the membranes of about 10° C. to about 45° C. The effect of pH and scale inhibitor on boron removal is not affected by changes in temperature. However, while the methods may be performed at temperatures below about 20° C., RO membranes are inherently more effective at rejecting boron at these lower temperatures and the pH adjustment step may not be needed. The methods may be performed at normal operating pressures of a reverse osmosis membrane, such as about 800 to about 1500 psi (about 5500 to about 10, 000 kPa), in another embodiment about 800 to about 1200 psi (about 5500 to about 8200 kPa), and in a further embodiment about 900 to about 1000 psi (about 6100 to about 6800 kPa). In an exemplary process, saline water is provided at about 12 to about 75 gpm (about 45 to about 284 liters/min) for an 8 inch (about 100 mm) diameter by 40 inch (about 1000 mm) long element.

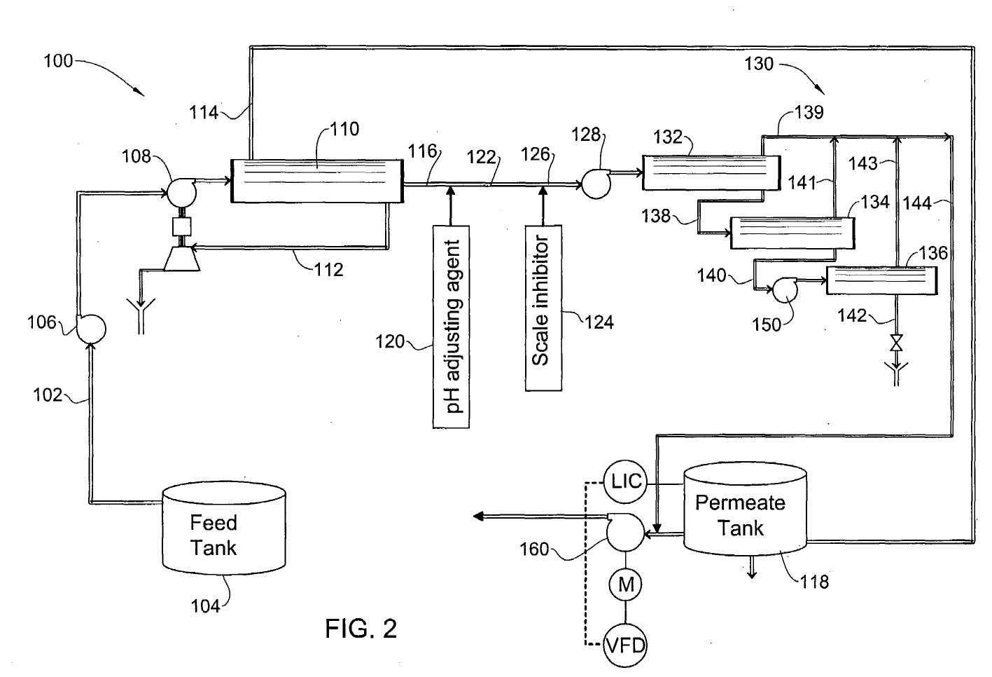

FIG. 2 depicts a configuration containing a two pass RO system in accordance with one embodiment of the invention.

As shown in FIG. 2, a system 100 is disclosed where high salinity liquid feed 102 is pumped from feed tank 104 by a high pressure pump 106. A second pump such as a booster pump 108 may be used for the introduction of the liquid to a first pass RO device 110. In RO device 110, operating at a recovery rate of about 45 to 55%, preferably about 50%, the high salinity liquid is separated into three streams: concentrate 112 which is transferred into a turbine or any power recovery device; front permeate 114 transferred into permeate tank 118 and rear permeate 116. The rear permeate 116 is then treated by adjusting its pH with pH adjusting agent 120 to a pH value of at least above 10. In one specific embodiment the pH is approximately 10.3. To the pH adjusted rear permeate 122 a scale inhibitor 124 is injected at a rate of 2-4 mg/liter, preferably at a rate of 3-4 mg/liter, to obtain a stream of modified first pass permeate 126. As already noted above, the order of addition of the base and scale inhibitor has no effect on the quality of the final product (the desalinated liquid), and the same results are obtained if the first pass permeate is first treated with the inhibitor and only thereafter with the pH adjusting agent. According to one embodiment, the base and/or the scale inhibitors are fed into the in-line fluid using a suitable dosing pump having an automatic feedback which automatically monitors and controls the amount of base and/or scale inhibitor which is added.

The modified first pass permeate 126 is then introduced by a pump 128 into a second pass RO system generally designated as 130. The second pass RO system 130 comprising in this particular embodiment a series of 3 sequential RO pass devices, 132 (e.g. 14×8 membranes), 134 (e.g. 6×8 membranes) and 136 (e.g. 2×8 membranes). Alternatively, the second pass system may be a multi RO stage system. The term “multi RO stage” is understood in the art to refer to a series of pressure vessels, whereas an “RO pass” is a device that is composed of one or more stages. The second RO pass system may also utilize a booster pump 150 to increase the pressure of the following RO stage.

Ideally a booster pump, such as pump 150, is incorporated in between the series of RO stages, after at least the first RO stage in the series, preferably before the last RO stage in the series to ensure desired operational fluxes of liquid between the different RO devices in the second pass RO system.

Each RO device produces two streams: concentrates 138, 140 and 142, respectively, and rear permeates 139, 141 and 143, respectively, which are blended to a single stream of a second pass permeate 144. It is to be noted that concentrates 138 and 140 are typically further desalinated while concentrate 142 is brine that is to be disposed.

The second pass permeate 144 operates at a significantly high recovery rate of between about 85% to about 98% and preferably at a recovery rate of between about 90% to 95%, more preferably, about or above 95%.

The front permeate 114 is delivered into the permeate tank 118. The liquid in the permeate tank 118 is suitable for supply to the end user. The liquid in the tank 118 may also be used for periodic handling of the RO devices, e.g. when suck back of liquid is required to push concentrate away from a membrane, e.g. in a shut down or for internal water demand (e.g. for periodic washing of membranes).

The second pass permeate 144 is connected to a suction of the supply pump 160 which is then supplied to the end user.

The operation of the two pass RO system may be controlled by a suitable control unit (not shown). The control unit is also operable to control the level of the liquid in the permeate tank 118, the operation of the different pumps etc. The level of liquid in the permeate tank 118 may be controlled by appropriate sensors, such as optical sensors, weight sensor etc.

In the system exemplified in FIG. 2 the level of liquid in the permeate tank is sensed by a Level Indicator Control (LIC), the velocity of pumping is controlled by a Variable Frequency Drive (VFD), and pumping is operated by the aid of a motor (M).

As appreciated by those versed in the art, the separation between the two permeates is required in order to avoid damage to the SWRO membrane, due to the high pH, in cases where the liquid in the permeate tank is required for treatment of the RO devices (e.g. for suck back or for purging the RO membranes). The overall recovery rate of the first and second pass is between about 30% and about 54% and the boron concentration in the blended permeate is below 0.4 ppm boron concentration and preferably below 0.3 ppm.

Typical process parameters for a configuration as shown in FIG. 2 are tabulated in the following non-limiting Example.

In the following Example, seawater were treated in accordance with the invention making use of a system as disclosed above and the results and of the RO method of the invention were calculated using IMS Design. In these calculations, seawater temperature of 25° C. was assumed, as well as RO seawater membrane SWC4+ (Hydranautics) for the first pass and RO brackish water membrane ESPAB (Hydranautics) for the second pass. The pH adjustment was achieved using caustic soda. It is noted that the concentration of the pH adjusting agent is determined based on parameters of the high salinity liquid to be treated, i.e. it is site specific. Those versed in the art would know how to determine the concentration of the base to be dosed into the liquid based on conventional measurements.

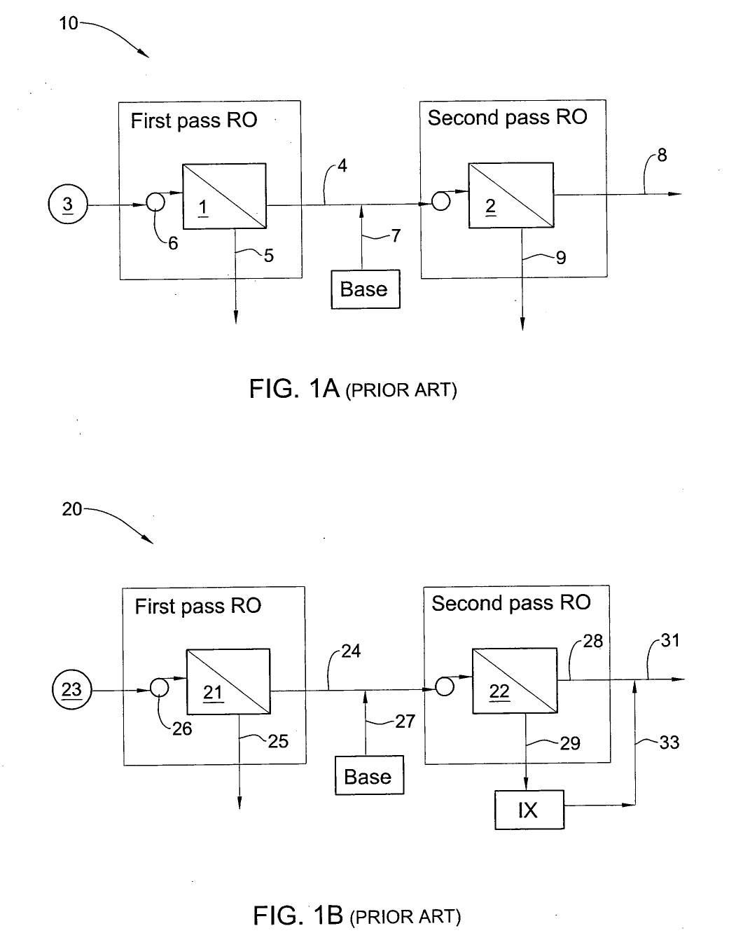

The results of treatment were compared to those of the two conventional two pass RO system described in WO 2005/056166 (as described with reference to FIGS. 1A and 1B herein) as shown in the following Table.

TABLE 1
Comparative process parameters

| Parameter | FIG. 1B | FIG. 1A | Current Example |
|---|---|---|---|
| Recovery Rates | | | |
| 1^{st} pass RO (R1) | 45% | 45% | 50% |
| 2^{nd} pass RO (R2) | 80% | 90% | 95% |
| Ion exchange (R3) | 98% | — | — |
| 3^{rd} pass RO (R3) | — | — | — |
| Combined (Rt) | 44.8%¹ | 40.5%² | 48.7% |
| 1^{st} pass RO permeate flow (Q1) | 10,041 m³/day | 11,111 m³/day | 10,800 m³/day |
| 1^{st} pass feed salinity (FC1) | 35,000 ppm TDS | 35,000 ppm TDS | 37,000 ppm TDS |
| 1^{st} pass feed boron conc. (FB1) | 5 ppm | 5 ppm | 5 ppm |
| 1^{st} pass permeate | | | |
| salinity (TDS1) | 267 ppm | 281 ppm TDS | 290 ppm |
| boron concentration (B1) | 1.5 ppm | 1.5 ppm | 0.93 ppm |
| 2^{nd} pass RO feed pH (pH F2) | 10 | 10 | 10.3 |
| 2^{nd} pass permeate (stages 1 and 2 if | | | |
| applicable) | | | |
| flow (Q2) | 8,032 m³/day | 10,000 m³/day | 5,520 m³/day |
| salinity (TDS2) | 8 ppm | 12 ppm | 36 ppm |
| boron concentration (B2) | 0.42 ppm | 0.5 ppm | 0.12 ppm |
| 2^{nd} pass permeate (stages 3 & 4) | | | |
| flow (Q2b) | — | — | |
| salinity (TDS2b) | — | — | |
| boron concentration (B2b) | — | — | |
| Ion exchange effluent | | | |
| flow (Q3) | 1,968 m³/day | — | |
| salinity (TDS3) | 1350 ppm | — | |
| boron concentration (B3) | 0.1 ppm | — | |
| Combined permeate flow (Q) | 10,000 m³/day | — | 10,500 m³/day |
| Combined flow salinity (TDS) | 272 ppm | — | 84 ppm |
| Combined boron concentration (B) | 0.36 ppm | — | 0.28 ppm |
| 2^{nd} pass concentrate | | | |
| Ca²⁺ concentration | 4 ppm | 8.4 ppm | 53 ppm |
| Mg²⁺ concentration | 12.3 ppm | 25.9 ppm | 88 ppm |
| CO₃²⁻ concentration | 11.8 ppm | 24.9 ppm | 34 ppm |
| HCO₃⁻ concentration | 15.8 ppm | 32.1 ppm | 24 ppm |

¹Rt = R1 × R2 = 0.45 × [0.8 + (0.2 × 0.98)];
²Rt = R1 × R2 = 0.45 × 0.90

The comparative results provided in the above Table 1 clearly show that the method of the present invention provide a significant increase in boron rejection rate in a high salinity liquid, such as seawater, while avoiding scaling of the second pass RO membranes by calcium carbonate or magnesium hydroxide. This is achieved without the need of an ion exchange treatment or transfer of the liquid at low recovery rates.

Specifically, Table 1 shows that the conditions of treatment in accordance with the present invention provide a higher recovery rate of the 2^{nd} pass permeate (95% vs. 90% or 80% with prior art methods), lower boron concentration in 2^{nd} pass permeate (0.12 ppm vs. 0.5 ppm and 0.42 ppm with prior art methods) as well as improvement in other parameters as lower total salinity.

The method of the present invention allows the reduction of boron concentration to low levels as 0.4 mg/l and below simultaneously with increasing the recovery rate to 95% and higher.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

1. A method for reducing boron concentration in a process of desalination of high salinity liquid, the method comprising: passing said high salinity liquid through a first pass reverse osmosis (RO) device to produce a first pass permeate, treating at least part of said first pass permeate with a scale inhibitor to obtain a modified first pass permeate, feeding said modified first pass permeate into at least one additional RO device to produce at least one additional pass permeate, thereby obtaining desalinated liquid having a boron concentration lower than that in the high salinity liquid.

2. The method of claim 1, comprising:
(i) passing said high salinity liquid through a first pass reverse osmosis (RO) device to produce a first pass permeate;
(ii) treating said first pass permeate, or at least a portion thereof, with a base to adjust the pH value of said first pass permeate to be at least above 10 and with a scale inhibitor a to obtain a modified first pass permeate;
(iii) passing the modified first pass permeate through at least one additional RO device to obtain at least one additional pass permeate with a boron concentration lower than that in the high salinity liquid.

3. The method of claim 1, comprising:
(i) passing the high salinity liquid through a first pass reverse osmosis (RO) device to produce a front first pass permeate and a rear first pass permeate;
(ii) treating the rear first pass permeate or at least a portion thereof with a base to adjust the pH value of the rear first pass permeate to be at least above 10 and with a scale inhibitor, to obtain a modified rear first pass permeate;
(iii) passing the modified rear first pass permeate, or a portion thereof, through at least one additional RO device to produce at least one additional pass permeate;
(iv) combining the front first pass permeate with the at least one additional pass permeate to produce desalinated liquid (blended flow) with a boron concentration lower than that in the high salinity liquid.

4. The method according to claim 1, wherein the base is sodium hydroxide or potassium hydroxide.

5. The method according to claim 1, wherein the scale inhibitor inhibits the formation of scale of at least magnesium hydroxide.

6. The method according to claim 4, wherein the scale inhibitor is selected from the group consisting of polycarboxylate, polyacrylate, polyphosphonate, polysufonic acid, polyphosphonic acid and polyphosphate, and a mixture thereof.

7. The method according to claim 5, wherein the scale inhibitor is selected from the group consisting of sodium-1-hydroxyethylidene-1,1-diphosphonate (HEDP), polyamino polyether methylenephosphonate (PAPEMP), 2-phosphonobutane-1,2,4-tricarboxylic acid (PBTCA), polymaleic acid (PMA), aminotri(methylene phosphonic acid) (AMP), hexamethylene diamine tetra (methylene phosphonic acid) (HDMTMP), copolymer of acrylic acid and acrylamido-2-methylpropylsulfonic acid (AA/AMPS), phosphoncarboxylic acid (POCA) and polyacrylic acid having a molecular weight of between about 100 to about 5000.

8. The method according to claim 1, wherein said treatment with a scale inhibitor is performed at a solution pH of at least above 10.

9. The method according to claim 2, wherein the pH is in the range of between about 10 to 11.

10. The method according to claim 8, wherein said pH is between about 10 to 10.4.

11. The method according to claim 9, wherein said pH is 10.3.

12. The method of claim 1, wherein the at least one additional RO device comprises at least two arrays of RO membranes.

13. The method of claim 1, wherein the high salinity liquid comprises a concentration of total dissolved salts (TDS) of at least about 1000 ppm.

14. The method of claim 12, wherein said concentration of total dissolved salts (TDS) is at least about 10,000 ppm TDS.

15. The method of claim 13, wherein said high salinity liquid is seawater.

16. The method of claim 1, wherein the recovery rate of the at least one additional pass permeate is in the range of between 90% and 98%.

17. The method of claim 15, wherein said recovery rate is equal or above 95%.

18. The method of claim 1, wherein the desalinated liquid comprises a boron concentration below or equal to 0.5 ppm.

19. The method of claim 17, wherein the desalinated liquid comprises a boron concentration below or equal to 0.4 ppm.

20. The method of claim 17, wherein the desalinated liquid comprises a boron concentration below or equal to 0.3 ppm.

21. The method of claim 1, wherein the desalinated liquid comprises a total salinity less than 90 ppm.

22. The method of claim 3, wherein the desalinated liquid is a combination of the front first pass permeate and the at least one additional pass permeate.

23. Desalinated liquid obtainable by the method of claim 1.

24. Desalinated liquid obtained by the method of claim 1.

25. The desalinated liquid of claim 22, comprising a boron concentration below or equal to 0.5 ppm.

26. The desalinated liquid of claim 22, comprising a boron concentration below or equal to 0.4 ppm.

27. The desalinated liquid of claim 22, comprising a boron concentration below or equal to 0.3 ppm.

28. The desalinated liquid of claim 22, comprising a total salinity of less than 90 ppm.

29. An array for desalination of high salinity liquid substantially as exemplified and described in FIG. 2.

30. A method for desalination of high salinity liquid substantially as exemplified and described herein in the description and drawings.
